(19) United States
(12) Patent Application Publication
(10) Pub. No.: US 2013/0339398 A1
(43) Pub. Date: Dec. 19, 2013

(54) DATABASE INBOX

(71) Applicants: Ryan Christopher Griggs, San Jose, CA (US); Dexter A. Dorris, Santa Clara, CA (US); Ryan David Shelby, Los Gatos, CA (US)

(72) Inventors: Ryan Christopher Griggs, San Jose, CA (US); Dexter A. Dorris, Santa Clara, CA (US); Ryan David Shelby, Los Gatos, CA (US)

(21) Appl. No.: 13/526,357

(22) Filed: Jun. 18, 2012

(51) Int. Cl. G06F 17/30

(52) U.S. Cl. 707/803; 707/E17.044

(57) ABSTRACT

A database inbox of the database management system can receive a data object. The database inbox can have an inbox display area. The database inbox can be configured to receive data objects each having a distinct data type. The database inbox can serve as a data shopping cart, storing the data objects in an ad hoc manner before a table for storing the data object in a database has been created.

### TECHNICAL FIELD

This disclosure relates generally to database applications.

### BACKGROUND

Many modern database tools integrate a database engine with a graphical user interface (GUI). The content of the database can be formatted and displayed in the GUI according to a layout, which can include data formatting information. In addition, a user may edit a schema of the database. A schema can include a definition of a logical structure for storing data in the database. For example, in a relational database, a schema can define tables and their relations. In a conventional database, a schema is created such that data can be stored in the structure defined by the schema. When there is no table in a database, the conventional workflow for storing data in the database can be, first, creating a schema for a table; second, creating the table based on the schema; and third, storing the data in the table. When there is a table in the database but the table does not have a column for storing the data, the conventional workflow for storing the data can be, first, modifying the schema to add a new column to the table; second, creating the new column for the table according to the modified schema; and third, storing the data in the new column.

### SUMMARY

Methods, program products, and systems for a database inbox are described. A database inbox of the database management system can receive a data object. The database inbox can have an inbox display area. The database inbox can be configured to receive data objects each having a distinct data type. The database inbox can serve as a data shopping cart, storing the data objects in an ad hoc manner before a table for storing the data object in a database has been created.

A database management system can receive, from a user interface, a first data object, a second data object, and a relationship relating the first data object and the second data object. The system can determine that a database table does not exist for the first data object and the second data object, the table reflecting the relationship. The system can create a database table having a first data field for the first data object, a second data field for the second data object, and the relationship. The system can then store the first data object and the second data object in the created table according to the relationship.

A database inbox of the database management system can receive a data object. The database inbox can have an inbox display area. The database inbox can be configured to receive data objects each having a distinct data type. The system can receive a request to insert the data object into a data record having one more data fields, each data field having a data field type, the data record corresponding to a form display area. The request can include an input that moves the data object from the inbox display area to the form display area. The system can determine whether the data object is moved to an existing data field. The system can then modify at least one of the data object or a schema of the data record such that a representation of the data object is inserted into the data record and provided for display in the form display area.

Dynamic schemas can be implemented to achieve the following advantages. A user can design a database schema “on the fly.” The user is not required to have a proper database schema before the user gathers data items and determines how the data items should relate to each other. Data can be stored in a database in an ad hoc manner. The user can organize the data when, for example, data collection activities have been completed. The database inbox provides a shopping cart environment in which a user can place data items of different types, and then insert the data items in the shopping cart environment into database tables.

For example, a user can be in a browser browsing web content. When the user finds interesting content, the user can send the content to a database. To send the content to the database, the user can tap or click on an image, tap or click on a web address, and tap or click on a text segment. The image, web address, and text segment can be stored in a database inbox. The user can later create a database table having a column for images, a column for web addresses, and a column for text strings to store the image, web address, and text string by dragging and dropping actions. In some implementations, content added to a pasteboard in an operating system by a program outside of a database application program can be added to a database inbox of the database application program when the outside program launches the database application program, or when a user switches from the outside program to the database program.

The techniques of dynamic schemas in a backend and database inbox in a frontend can make a workflow of designing a database more natural, starting from identifying concrete data and then creating a structure for the data, comparing to conventional database management systems, which can often require a user to have an abstract schema first before actual data can be entered. In some operating systems, a data type can be obscure. For example, a file system can be hidden from a user, such that the user does not see a file type. Ad hoc schema creation based on content can offer a user a convenient way to create a database table without requiring the user to understand what data type is underlying the data and then design the schema based on the data type.

The details of one or more implementations of dynamic schema and database inbox are set forth in the accompanying drawings and the description below. Other features, aspects, and advantages of dynamic schema and database inbox will become apparent from the description, the drawings, and the claims.

### BRIEF DESCRIPTION OF THE DRAWINGS

FIG. 1 is an exemplary user interface for a database inbox.

FIG. 2 is an exemplary user interface for adding data objects to a database inbox.

FIG. 3 is an exemplary user interface for dynamically modifying data when data are inserted into a database from a database inbox.

FIG. 4 is an exemplary user interface for pushing data from an application program into a database inbox.

FIG. 5 is an exemplary user interface for dynamically creating a table definition using a database inbox.

FIG. 6 is a block diagram illustrating exemplary components of a database inbox.

FIG. 7 is a block diagram illustrating exemplary dynamic database interface.

FIG. 8 is a flowchart illustrating an exemplary process of operations of a database inbox.

FIGS. 9A-9C are flowcharts illustrating exemplary processes of operations of a dynamic database schema.

FIG. 10 is a block diagram of an exemplary system architecture for implementing the features and operations of FIGS. 1-8 and 9A-9C.

Like reference symbols in the various drawings indicate like elements.

### DETAILED DESCRIPTION

### Overview

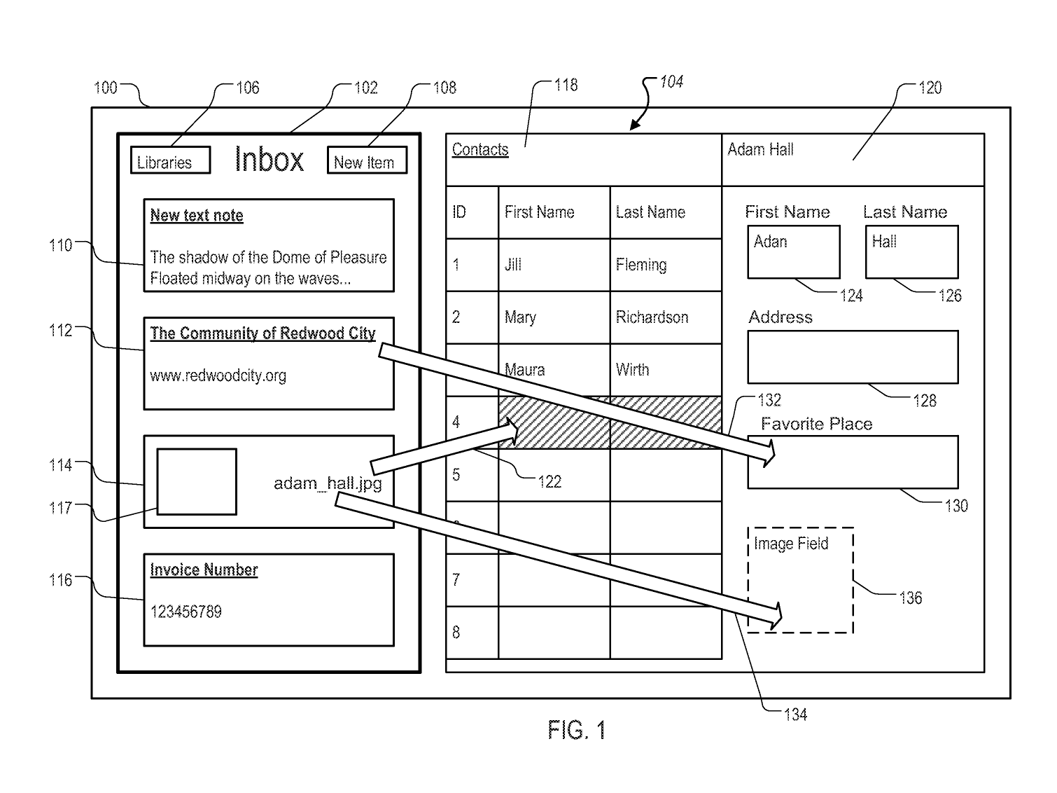

FIG. 1 is exemplary user interface 100 for a database inbox. A database inbox can include computer instructions that, when executed by a processor, causes the processor to receive and store data objects of arbitrary types on a storage device. The database inbox can operate as a data shopping cart for a database, before data fields for the data objects were created. The database schema can be dynamic. A data field can be arbitrarily created based on data objects in the database inbox.

User interface 100 can be a component of a database application program. User interface 100 can be displayed on a touch-sensitive display screen. User interface 100 can include database inbox display area 102 and data display area 104. Database inbox display area 102 can be a front end of a database inbox. Database inbox display area 102 can be configured to receive data objects, e.g., text items, uniform resource locators (URLs), or images. The received data object can be stored in the database inbox.

Database inbox display area 102 can display database selector 106 and new item control 108. Database selector 106 can be a user interface item that, when activated, causes a list of one or more databases, also referred to as libraries, to be displayed. Upon receiving a selection of a database from the list, the database inbox can connect to the selected database. The database inbox need not be connected to or associated with a database initially. The database inbox can be connected to a database after data objects are already stored in the database inbox. Then, the database inbox can insert data objects stored in the database inbox into a table in the now connected database. If the table into which the data objects are being inserted does not have a column for storing the data object, the database inbox can modify the schema of the table to create the column, and then insert the data.

In some implementations, the database inbox can allow a workflow that is a reversal of a conventional database application. For example, the database inbox can allow a user to collect data object first when a schema does not exist, create a schema that defines a table for storing the data object when a database does not exist, and then create a database for the schema.

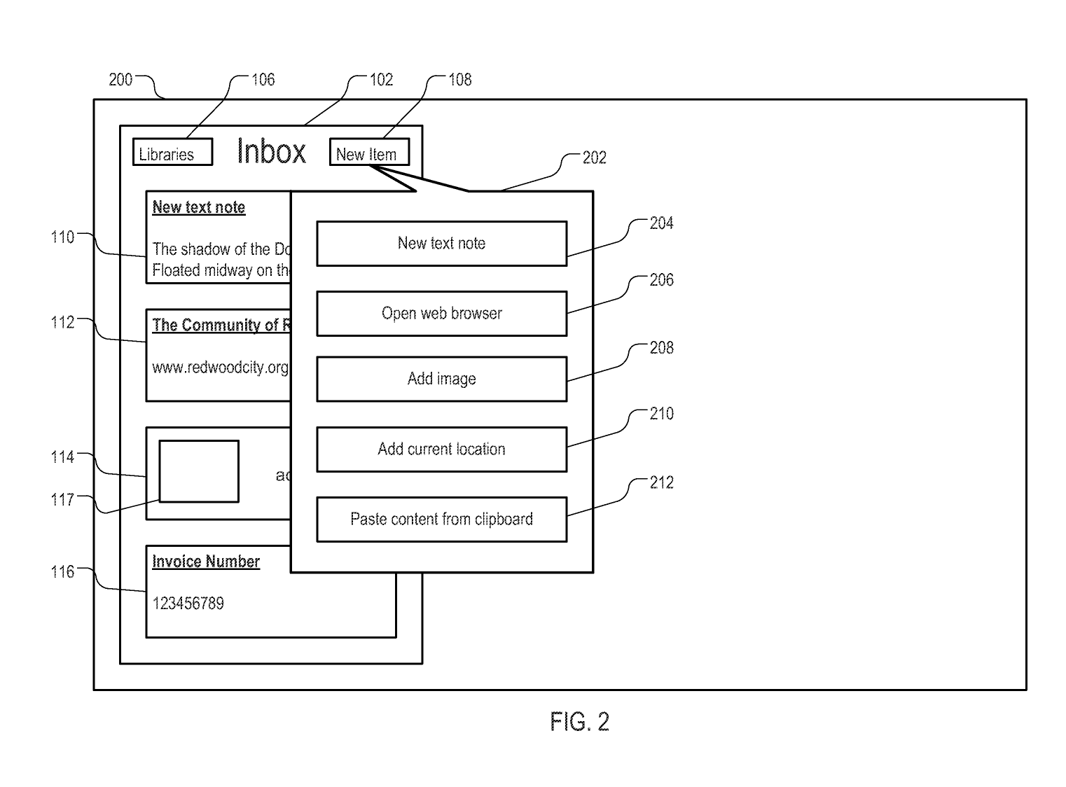

New item control 108 can be a user interface item that, when activated, can cause a new data object be added to the database inbox. Additional details of the operations of new item control 108 will be provided below in reference to FIG. 2.

The database inbox can store data objects each having a distinct type. Database inbox display area 102 can display data object placeholders 110, 112, 114, and 116 for displaying representations of the data objects. For example, data object placeholder 110 can display a text object; database object placeholder 112 can display a URL data object; database object placeholder 114 can display thumbnail 117 of an image object; database object placeholder 116 can display a complex data object “invoice” which can have multiple subcomponents.

User interface 100 can include data display area 104. When a database application program connects to a database, the database application program can display data of the database in various views. For example, the data can be displayed in a form view, in which data records stored in the database can be displayed one record at a time. The data can be displayed in a table view, in which multiple data records can be displayed in a tabular format like a spreadsheet. In a table view, each data record can appear in a row, and each data field in the record can appear in a column. The data can be displayed in a list view, in which data records are displayed in a list format, one record at a time. Data display area 104 can be formatted using a layout, which can include an arrangement of data fields, data objects, images, and layout parts (e.g., headers, titles). The layout can represent a way information is organized and presented when a user browses, previews, or prints data records. Data display area 104 can include table view 118 and form view 120.

The database inbox can receive a user input in database inbox display area 102 for moving a data object from database inbox display area 102 to data display area 104. For example, the input can include a touch input (e.g., a stylus or finger touching a touch-sensitive screen) selecting one or more of data object placeholders 110, 112, 114, or 116, a drag input dragging the selected placeholder to data display area 104, and a drop input (e.g., the stylus or finger leaving the screen) leaving the placeholder in data display area 104. A data object represented in the placeholder, as stored in the database inbox, can be inserted to a database field in the record.

For example, the database can be a database of contacts. A tabular view of contacts can be displayed in table view 118. A data record of a contact can be displayed in form view 120. The database inbox can receive an input 122 dragging data object placeholder 114 and dropping data object placeholder 114 to an empty row in table view 118 in a “first name” or “last name” data field. The database inbox can determine that a new data record shall be created based on the data object. The database inbox can create the new data record, and fill in data fields in the data record based on the data object.

In this example, the data object is an image. The database inbox can apply rules for converting the image into data most likely to match the type of the data field to which the data object is going to be inserted. A conversion rule can specify that, when converting an image into text, the database inbox shall (1) use text recognition techniques to recognize text in the image, or (2) parse the image metadata, including, for example, a title of the image, or the exchangeable image file format (Exif) data of the image. The database inbox can determine, based on the title of the image, words “adam” and “hall” can be identified. The database inbox can present a user interface asking whether the user wishes to use “adam” or “hall” as a first name or last name in the newly created data record.

In form view 120, data fields of a currently active data record (e.g., data record number 4) can be displayed according to the layout. The data fields can include data fields 124, 126, 128, and 130. Each of the data fields 124, 126, 128, and 130 can have a data type. The data inbox can receive input 132. Input 132 can drag data object placeholder 112 to data field 130. Upon receiving the input, the database inbox can create or modify data of data field 130 based on the URL data object associated with data object placeholder 112.

The database inbox can create or modify a schema of the database, including creating or modifying definitions of data fields of a data record. For example, the database inbox can receive input 134, which drags data object placeholder 114 to form view 120. The data inbox can determine that input 134 places data object placeholder 114 outside of any data field in form view 120. Upon making the determination, the database inbox can create new data field 136 in the schema of the data record. New data field 136 can have a type corresponding to a type of the data object. For example, upon detecting that the data object is an image, the database inbox can create a container type data field in the schema. The container type data field can be a data field designated for storing multimedia content, a file, or a complex data object. The database inbox can modify the layout underlying form view 120 to display new data field 136. The database inbox can modify the schema for all data records in the database of contacts.

### Exemplary User Interface

FIG. 2 is exemplary user interface 200 for adding data objects to a database inbox. A database inbox can receive an input for creating a new data object in the database inbox. The input can be a click or touch on new item control 108. Upon receiving the input, the database inbox can provide for display new object interface 202. New object interface 202 can be a user interface item for creating a data object in the database inbox without relying on an existing schema. New object interface 202 can include a list of controls, for example, text note control 204, browser control 206, image control 208, location control 210, and clipboard control 212.

Text note control 204, when activated, can cause a text editor to be displayed. The text editor can receive text input and save the text input as a data object in the database inbox. Browser control 206, when activated, can cause a web browser to open. The database inbox can store a URL of the web browser or content displayed in the web browser as a data object. Image control 208, when activated, can cause an image selector to be displayed. The database inbox can store an image as selected by the image selector as a data object. Location control 210, when activated, can cause a current location of a device hosting the database inbox to be stored as a data object in the database inbox. Clipboard control 212, when activated, can cause content stored in a clipboard to be stored in the database inbox.

The controls of new object interface 202 can be used to pull objects from another application program into the database inbox. In some implementations, browser control 206 can cause a web browser to be displayed. The web browser can display a web page that includes content items, e.g., text segments, images, and links. When browser control 206 is activated, the content items can be individually selectable. Upon receiving a selection input, the database inbox can convert a selected content item into a data object of a corresponding type, and store the data object in the database inbox.

When adding a data object in the database inbox, the database inbox can create an identifier for the data object. The identifier can be a unique identifier generated based on content of the data object. For example, when image control 208 is activated, the image selector can select an image, and create an identifier for the image based on a file name of the image, a type of the image (e.g., .jpg or .tiff), metadata (e.g., image creation date or image creation device) parsed from the image, or a hash value of the image. The file name, image type, metadata, and hash value can be concatenated to create the unique identifier.

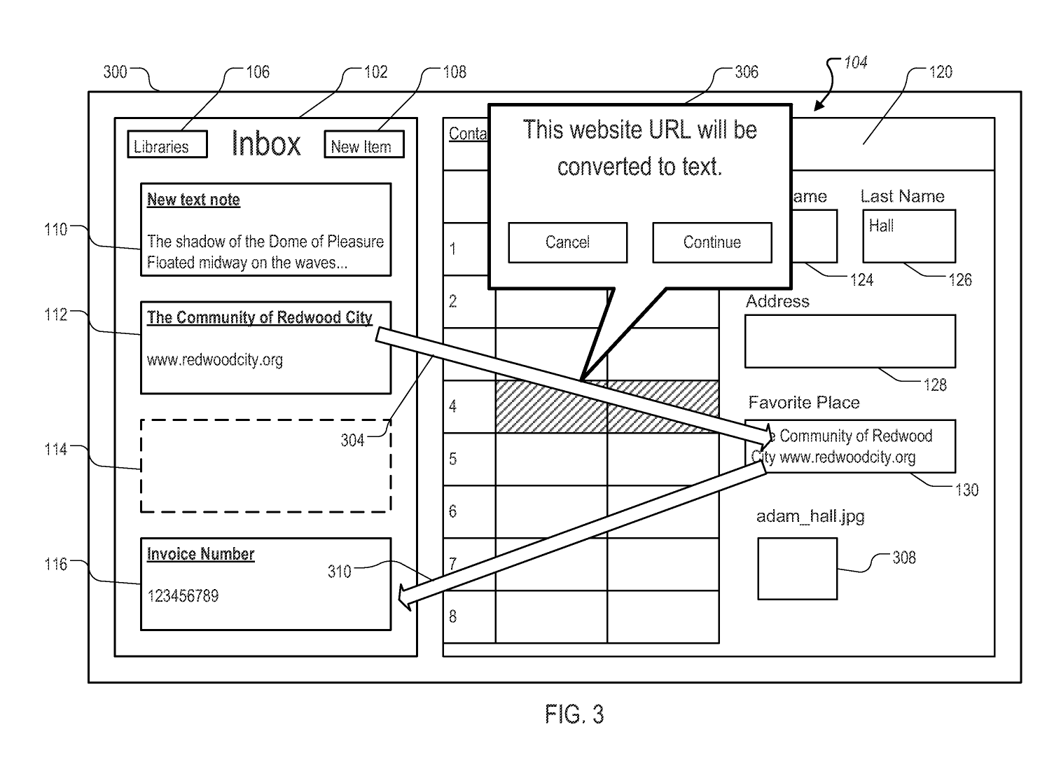

FIG. 3 is exemplary user interface 300 for dynamically modifying data when data are inserted into a database from a database inbox. Database inbox display area 102 can receive input 304 moving data object placeholder 112 to data field 130 in form view 120. Data object placeholder 112 can be associated with a data object having a URL object type. A data object having a URL object type can include text, a hyperlink associated with the text, and formatting information (e.g., font or color) associated with the text. Data field 130 can have a text type. Upon receiving input 304, the database inbox can determine that the data type for the database object being moved and the data type of the destination data field are not the same. The database inbox can identify, from a rule mapping table, a rule for converting a data object having a URL object type to a data object having a text type. Upon identifying the rule, the database inbox can provide conversion dialog box 306 for confirming whether a user intends to allow such conversion to happen. If the database inbox receives a confirmation that the user allows the conversion to happen, the data object represented in data object placeholder 112 is converted from a URL type to a text type. The data object having a text type can be inserted in data field 130.

Upon object conversion and insertion into a data field in form view 120, the data object in the database inbox can be removed. The database inbox can retain the placeholder of the data object in database inbox display area 102. For example, when the database inbox receives an input to move an image from data object placeholder to form view 120 as a new data field, the image can be displayed in new data field 308. The database inbox can retain data object placeholder 114. If the database inbox receives an undo command, the database inbox can retrieve the data object in the data field and place the data object back in the database inbox, and place a presentation of the data object back in the placeholder. If the data object has been type-converted, and the database inbox retains conversion information, the database inbox can restore the data object to the original object type. If the database inbox receives a commit input, the data object can be committed in the database. Any new data fields, e.g., data field 308, can be committed into the database schema.

In addition to providing data for an existing data field or a new data field in a schema, the database inbox can receive data objects from a database. For example, the database inbox can receive input 310. Input 310 can include a drag-and-drop input dragging and dropping data field 130 from form view 120 into database inbox display area 102. The database inbox can determine whether input 310 is an undo input for undoing a move of a data object from the database inbox to a database table. If the database inbox determines that input 310 is an undo input, the database inbox can represent a data object corresponding to data field 130 (e.g., the original URL object) back in the original object placeholder. The database inbox can undo any newly created schema as result of the original input of dragging and dropping object placeholder 112 to data field 130. If the database inbox determines that input 310 is not an undo input, the database inbox can create a new data object, and place a representation of the new data object in a new object placeholder in database inbox display area 102.

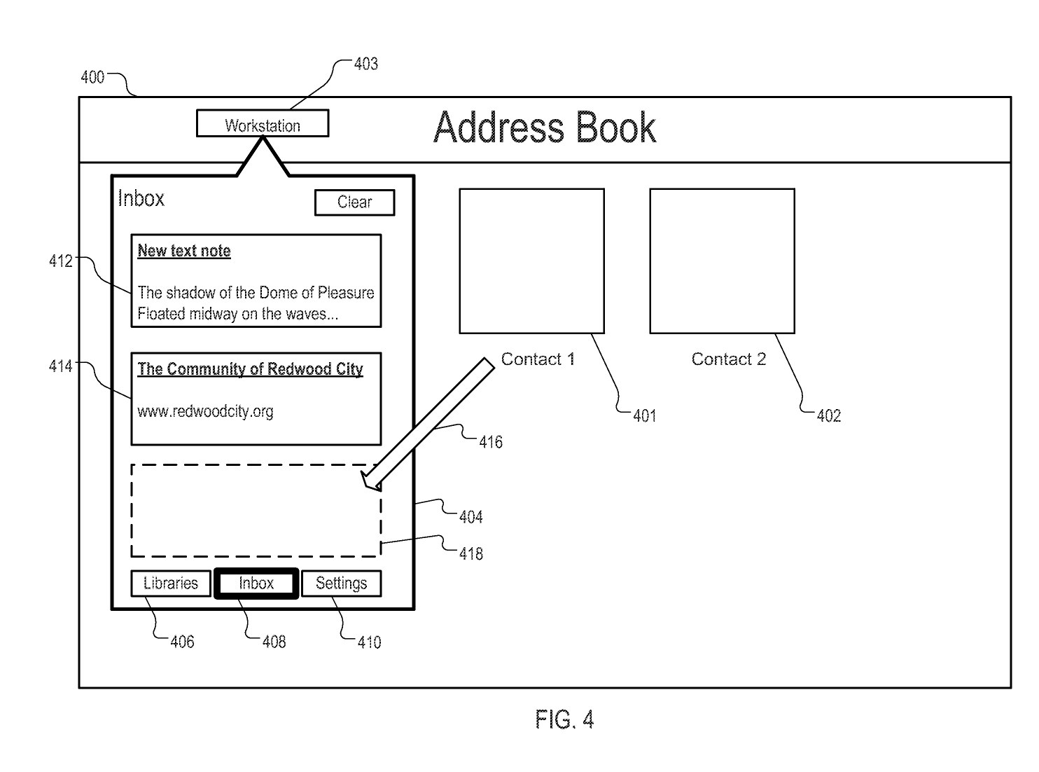

FIG. 4 is exemplary user interface 400 for pushing data from an application program into a database inbox. User interface 400 can be a graphical user interface of an application program (e.g., an “address book” program) configured to interface with the database inbox. The application program can interface with the database inbox through a plugin, which can be a software component for adding database inbox communication capability to the application program. Alternatively or additionally, the application program can interface with the database inbox through a built-in component programmed according an application programming interface (API) of the database inbox that specifies a communication protocol between the database inbox and application programs.

User interface 400 can include display objects 401 and 402. Each of display objects 401 and 402 can correspond to a data object for storing contact information. The data object can be a simple data object, e.g., a text object or an image object, or a complex data object that includes a data record having data fields for first name, last name, phone number, address, and other information.

User interface 400 can include settings control 403. Settings control 403 can be a graphical user interface item that, when activated, provides for display connection interface 404. Connection interface 404 can be a dialog box that includes database option control 406, database inbox option control 408, and settings option control 410. Database option control 406 can be a user interface item that, when selected, can cause the application program to be connected or synchronized with a database. Database inbox option control 408 can be a user interface item that, when selected, can cause the application program to connect to a database inbox. Settings option control 410 can be a user interface item that, when selected, can cause a settings dialog to be displayed.

In the example of FIG. 4, database inbox option control 408 is pre-selected. Accordingly, connection interface 404 can be a database inbox interface. The database inbox interface can include data objects placeholders 412 and 414, each displaying a representation of a data object. The database inbox can receive input 416 moving display object 401 from a display area outside of connection interface 404 into connection interface 404. Input 416 can be a drag-and-drop input.

Upon receiving input 416, the database inbox can create a data object based on display object 401. The database inbox can then create object placeholder 418 for displaying a representation of the created data object. The database inbox can store the object, to be inserted into a database table at a later time. At the time the database inbox stores the object, the database table or a column in the database table corresponding to the object may not have been created yet.

In various implementations, settings control 403 may be activated upon various inputs. For example, in a text displaying or text editing application program, settings control 403 can be activated when a section of text is selected upon a tap the selected text on a touch-sensitive display device. In a browser, settings control 403 can be activated when a display object is selected. A display object can be selected by a gesture, for example, of two fingers touching an item and then pulling apart, creating a crop box. In a database application program, e.g., in a list view, table view, or a form view of data, settings control 403 can be activated when a data field is selected. These manners of input can help a user to select content for inserting into database in an ad hoc manner.

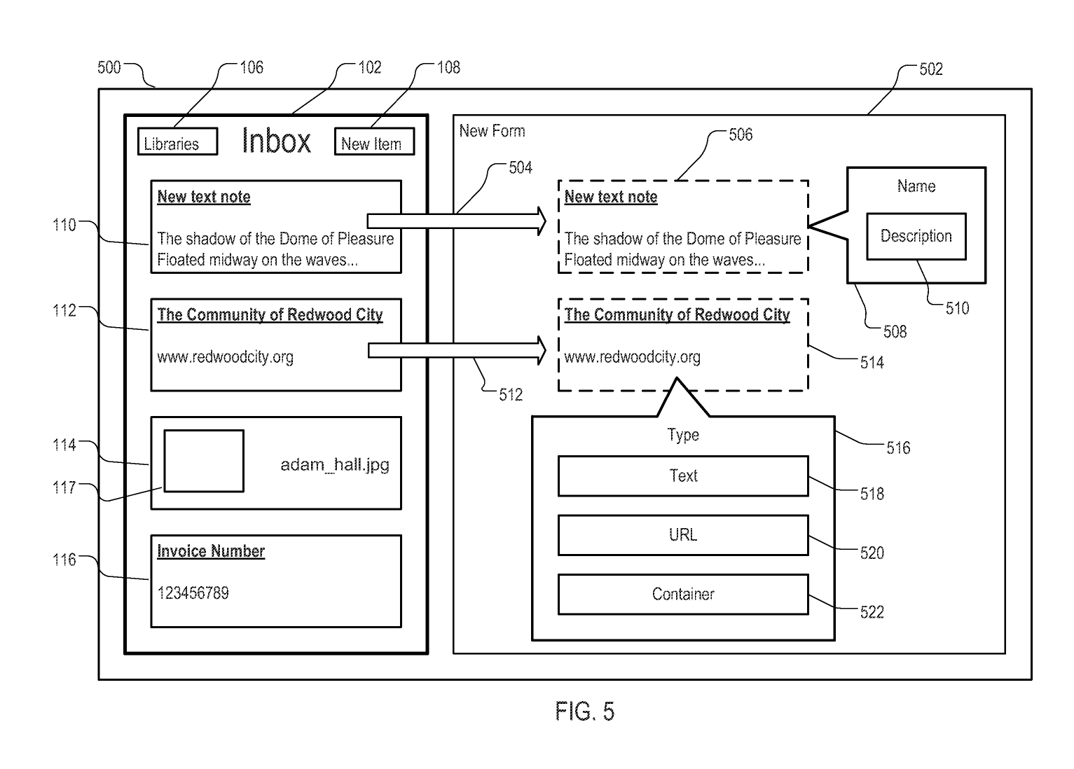

FIG. 5 is exemplary user interface 500 for dynamically creating a table definition using a database inbox. User interface 500 can include database inbox display area 102 and form display area 502. Database inbox display area 102 can correspond to a database inbox that already includes data objects. Form display area 502 can correspond to an empty form the schema of which has not yet been created.

The database inbox can receive input 504 moving data object placeholder 110 from database inbox display area 102 to form view 502. Upon receiving the input, and upon determining that no scheme exists for the empty form, the database inbox can create data field 506. The database inbox can determine a data type of data field 506 based on a data type of the data object corresponding to data object placeholder 110 and a data conversion rule. The data conversion rule can specify that a data object having a text data type correspond to a data field having a text data type. Accordingly, the database inbox can designate data field 506 as a text data field.

When new data field 506 is created, the database inbox can determine a field name automatically or based on user input. In some implementations, the database inbox can use a portion of the data object, e.g., the first complete word in a text string, as a default field name. In some implementations, when creating new data field 506, the database inbox can provide for display user interface item 508. User interface item 508 can be used to receive, through editing box 510, an input of a field name for new data field 506.

The database inbox can receive input 512 moving data object placeholder 112 from database inbox display area 102 to form view 502. Upon receiving input 512, the database inbox can create new data field 514 for the data object. The data object can have a URL object type. The database inbox can, upon determining that the data object has a URL object type, provide object type dialog 516 for display. Object type dialog 516 can include type selectors 518, 520, and 522. Type selectors 518, 520, and 522 when activated, can cause the database inbox to designate new data field 514 as a text data field, URL data field, or container data field, respectively.

The database inbox can receive a commit input. Upon receiving the commit input, database inbox can store a new schema defining data relations for the new form in a current database. The new schema can specify that a data record have two data fields, and each data field have a field type. The database inbox can give the new schema a name (e.g., “Contact”). The values of data objects corresponding to data object placeholders 110 and 112 can be stored in the database according to the new schema. In addition, the database inbox can associate a layout with the new schema. The layout can be determined based on locations of new field 506 and new data field 514 as placed in form view 502 by input 504 and input 512, respectively.

### Data Storage

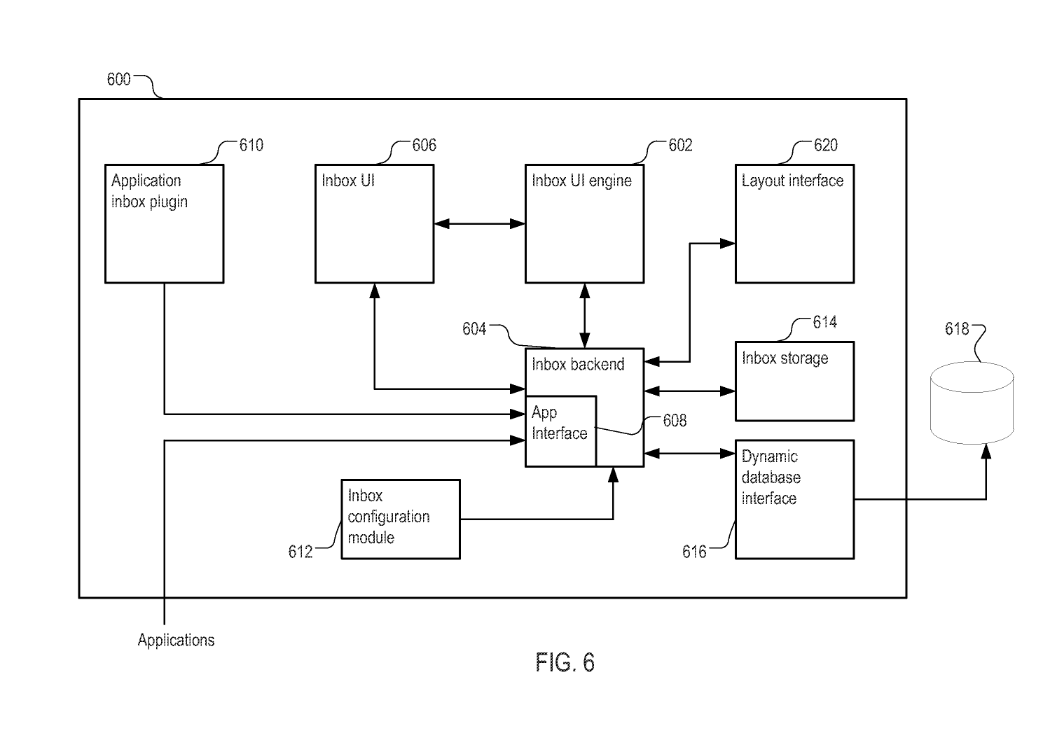

FIG. 6 is a block diagram illustrating exemplary components of a database inbox. A database inbox can be implemented on system 600. System 600 can include inbox user interface engine 602 and inbox backend engine 604. Inbox user interface engine 602 can be configured to generate and manage database inbox user interface 606. Database inbox user interface 606 can include database inbox display area 102 and various inbox-related dialog boxes as described above in reference to FIGS. 1-5.

Inbox backend 604 can provide inbox-specific logics for database inbox user interface 606. For example, inbox backend 604 can specify an inbox limit such that when data objects in the database inbox exceeds the inbox limit, the database inbox can refuse to accept more data objects, or organize the data objects in a hierarchical structure having multiple levels such that data objects at each level do not exceed the limit. The limit can be a limit in count or limit in total size. In addition, inbox backend 604 can manage relations between data object placeholders and data objects, for example, by tracking which data object placeholder belongs to which data object. When inbox backend 604 receives an undo input, a data object already moved to a data field can be placed back into the data object's data object placeholder in inbox user interface 606 according to the relations.

For example, inbox backend 604, upon receiving a new data object, can detect that, if the database inbox accepts the new data object, an inbox limit (e.g., 99 objects) will be exceeded. Inbox backend 604 can then organize the database inbox by data object type. Inbox backend 604 can create an “image” folder and a “URL” folder and move all image objects and URL objects in a top level into the respective folder to reduce the total number of data objects at the top level, such that, when the new object is stored, the total number of data objects at the top level is at or below the inbox limit.

Inbox backend 604 can include application interface 608. Application interface 608 can receive input from and provide data to application inbox plugin 610. Application inbox plugin 610 can be a plugin as described above in reference to FIG. 4. In addition, the application interface can include functions programmed based on a database inbox API for communicating with other application programs.

Inbox backend 604 can interact with inbox configuration module 612. Inbox configuration module 612 can be utilized to create or modify parameters of the database inbox and affect how inbox backend 604 operates. For example, inbox configuration module 612 can provide an interface for specifying the inbox limit, and an interface for specifying object type conversion rules to be applied when the database inbox receives an input to move a data object of a first type to a data field of a second type.

Inbox backend 604 can interact with inbox storage 614. Inbox storage 614 can include a storage device for storing data objects in the database inbox. Inbox storage 614 can store structured data (e.g., a data record having multiple data fields) or unstructured data (e.g., a file). The data stored in inbox storage 614 can be modified using a content editor. In addition, inbox storage 614 can store conversion information when a data object is converted from one type to another. The conversion information can be stored until inbox backend 604 receives a commit command confirming that the conversion will be stored permanently in a database.

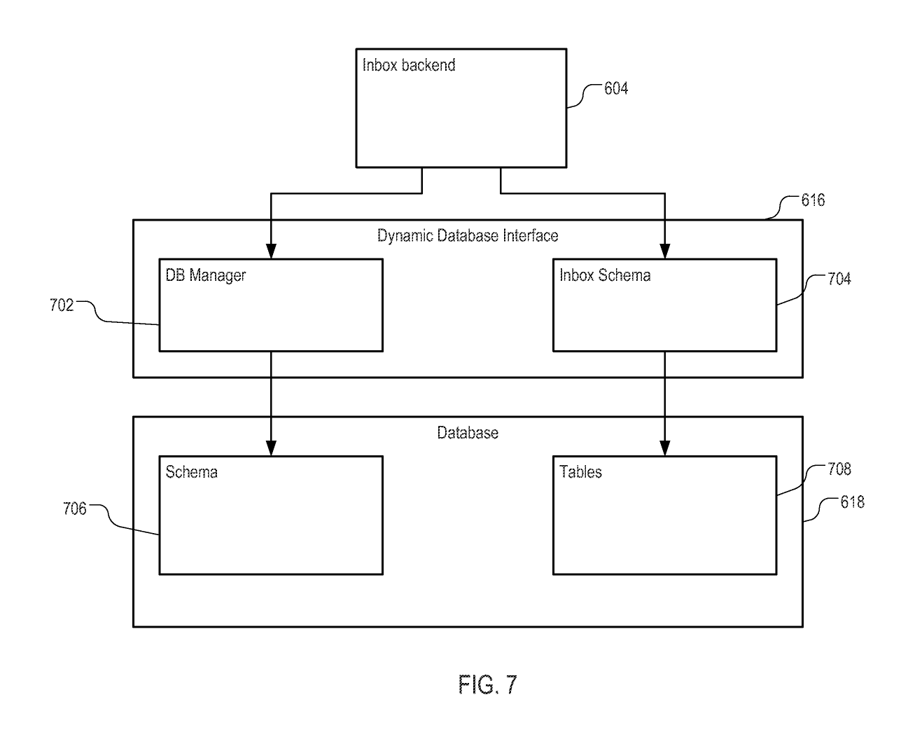

Inbox backend 604 can communicate with dynamic database interface 616. Dynamic database interface 616 can include component configured to manage interactions between a database inbox and database 618. Dynamic database interface 616 can include components for handling transactions with database 618, including modifying schema, modifying data, and committing data for database 618. Additional details of dynamic database interface 616 will be discussed below in reference to FIG. 7.

Inbox backend 604 can communicate with layout interface 620. Layout interface 620 can include software and hardware components for communicating with a layout editor. When a data object is moved from a database inbox to a form view, a layout of the form view can be created or modified to reflect the movement of the data object.

FIG. 7 is a block diagram illustrating exemplary dynamic database interface 616. Dynamic database interface 616 can include database manager 702 and inbox schema 704. Database manager 702 can create or modify database schema 706 based on instructions from inbox backend 604. The instructions can be based on user input received by inbox backend 604, data types of data objects stored in the database inbox, and operating parameters of inbox backend 604. In some implementations, database editor 702 can automatically create or modify database schema 706 after the database inbox has already received data for storage.

Inbox schema 704 can define a data structure for storing data objects in a database inbox. The data structure can be a system table in a database where there is one column and multiple rows. Each row can be a data record having one data field. Each row can represent a data object stored in the database inbox. Two data fields from two different rows of the system table can have different types, each type corresponding to the data object corresponding to the respective row. When a data object is moved from a database inbox to the database, dynamic database interface can transfer the represented in a corresponding row to a corresponding data field in database tables 708. The transferred data, as well as database schema 706 as created or modified by database editor 702, can be committed upon a commit command.

### Exemplary Processes

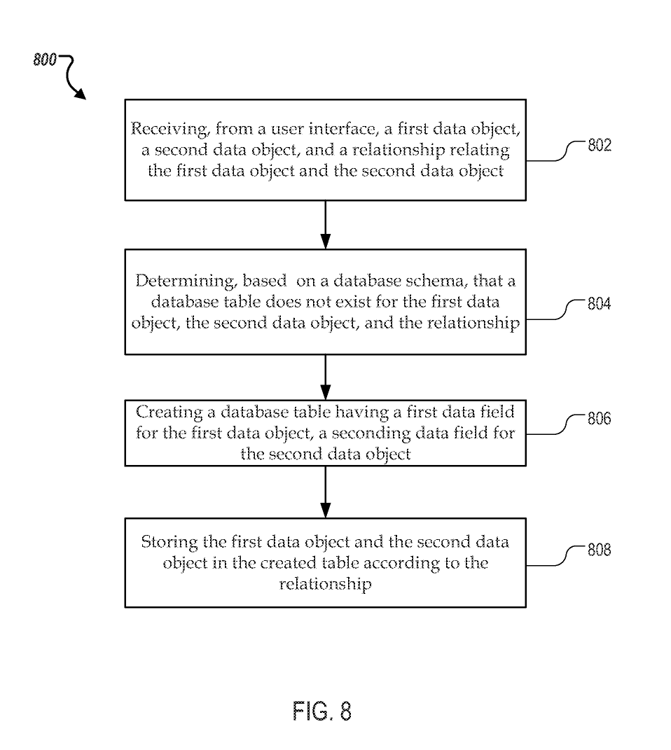

FIG. 8 is a flowchart illustrating exemplary process 800 of operations of a database inbox. A system, e.g., a mobile computing device, can receive (802) a first data object, a second data object, and a relationship relating the first data object and the second data object. The relationship can specify that the first data object and the second data object relate to each other in various manners. For example, the relationship can specify that the first data object and second data object be displayed in a same data record in a form view. The relationship between the first data object and second data object can include a one-to-one, one-to-many, or many-to-many relationship. The first data object, second data object, and relationship can be received from a user interface that includes a data display area configured to receive the first data object and the second data object from a database inbox display area outside of the data display area. The data display area can include at least one of a list view display area, a table view display area, or a form view display area.

In some implementations, the first data object can be exported from a first application program, e.g., a web page exported from web browser; the second data object can be exported from a second application program, e.g., an image exported from an image viewer. The relationship can specify that the exported image be inserted into the exported web page.

In some implementations, the relationship can specify that the first data object and the second data object be displayed in a form view. The form view can be provided for display according to formatting information for the first data object and second data object. The formatting information can be stored in a layout for the data record. The system can create a layout before creating a database table using the layout and modify the layout according to a user input (e.g., an input for placing a data object in the form view) received before creating the database table. The system can associate the layout and the database table after creating the database table. In some implementations, modifying the database table can include designating one of the first data object or second data object as a key to the database table in response to the user input.

In some implementations, each of the first data object and second data object can be associated with a same geographic location of the computing device. A first location can be determined at a time when the first data object is moved in the form view. A second location can be determined at a time when the second data object is moved in the form view. The relationship can specify that the first data object and second data object are related to each other when the first geographic location is the same or is proximate to the second geographic location.

The system can read and analyze a database schema. The system can determine (804), based on results of the analysis of the database schema, whether a database table exists for the first data object, the second data object, and the relationship.

Upon determining that a database table does not exist for the first data object, the second data object, and the relationship, the system can create (806) a database table having a first data field for the first data object, a second data field for the second data object. The database table can have a structure that reflects the relationship. For example, the database table can specify that the first data field and second data field be in two columns of the table. The system can create a layout for formatting fields of a database table before creating the database table.

The system can store (808) the first data object and the second data object in the created table according to the relationship. For example, the first data object and the second data object, when both associated with a same geographic location, can be stored in the table as a row for which the geographic location is a key.

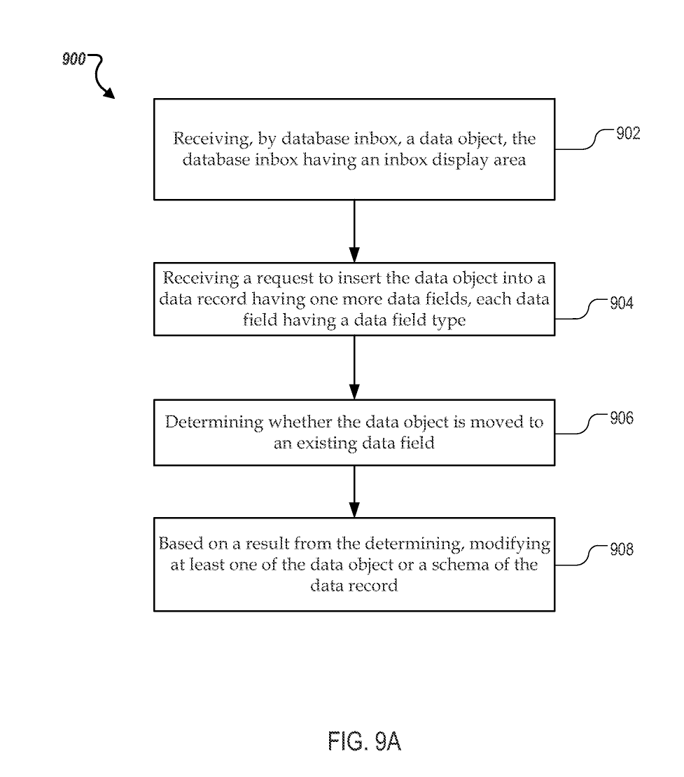

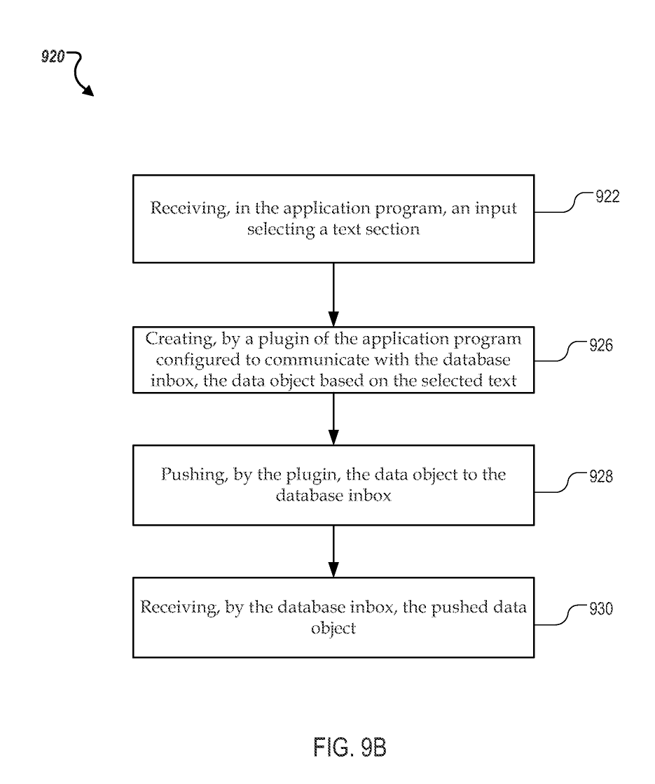

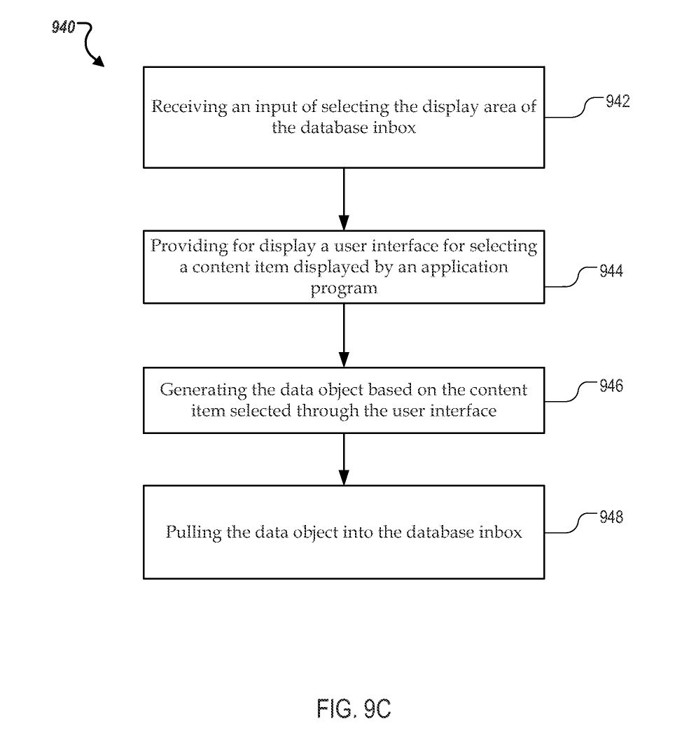

FIG. 9A is a flowchart illustrating exemplary process 900 of operations of a database inbox. A system, e.g., a mobile computing device, can implement a database inbox. The database inbox can receive (902) a data object. The data inbox can have an inbox display area. The database inbox can be configured to receive and store data objects each having a distinct data type. The data object can be received through a push by an application program, or through a pull by the database inbox from an application program. The operations of receiving a data object through a push or a pull will be described in further detail below in reference to FIGS. 9B and 9C, respectively.

The database inbox can receive (904) a request to insert the data object into a data record having one more data fields. The data record can be displayed in a form display area. Each data field can have a data field type. The request can include an input moving the data object from the inbox display area to the form display area. The database inbox includes a backend table. The backend table can have one or more data records organized in one data column. Each of the one or more data records having one data record that corresponds to a respective data object.

The database inbox can determine (906) whether the data object is being moved to an existing data field. Determining whether the data object is being moved to an existing data field can include determining whether a placeholder for displaying a representation of the data object was dragged and dropped in a data field, or in a form view area outside of any data field.

Based on results of determination made in stage 906, the database inbox can modify (908) at least one of the data object or a schema of the data record such that a representation of the data object is inserted into the data record and provided for display in the form display area. Modifying the data object can include determining an object conversion rule using a type-mapping table based on the data type of the data object and data field type of the existing data field. The database inbox can convert the data object into a target object according to the object conversion rule, and designate the target object as the representation of the data object. Converting the data object can include extracting metadata from the data object. The metadata can indicate one or more characteristics of a content item in the data object. Modifying the schema can include creating a new data field in the schema. The new data field can have a data field type that corresponds to the data type of the data object. The database inbox can propagate the new data field to other data records according to the schema.

In some implementations, upon receiving a data object, a database inbox can determine that a number of data objects in the database inbox exceeds a threshold. The database inbox can then create multiple levels in the database inbox, including creating at least one folder at a first level. The folder can contain at least two data objects moved from the first level to a second level, such that a total number of data objects and folders at the first level does not exceed the threshold.

FIG. 9B is a flowchart illustrating exemplary process 920 for receiving a data object through a push. An application program can receive (922) an input selecting a content item, e.g., a text section, an image, a table, a web link, or an object. The input can be a touch input on the content item. A plugin of the application program can create (926) a data object based on the selected content item. The plugin can push (928) the data object to a database inbox. The database inbox can then receive (930) the pushed data object.

FIG. 9C is a flowchart illustrating exemplary process 940 for receiving a data object through a pull. A database inbox can receive (942) an input in a database inbox display area. The input can be a touch or a click on virtual button, e.g., a new item control 108 of FIG. 2. The database inbox can provide (944) for display a user interface for selecting a content item displayed by an application program. The user interface can include a display of a currently active program, with each content item for which a data object can be generated can be highlighted. For example, in a contact list, each contact can be displayed as an icon. A highlighted frame can be added to each icon, indicating that the contact represented by the icon can be pulled into the database inbox.

The database inbox can generate (946) a data object based on the content item selected through the user interface. The database inbox can then pull (948) the data object into the database inbox.

### Exemplary System Architecture

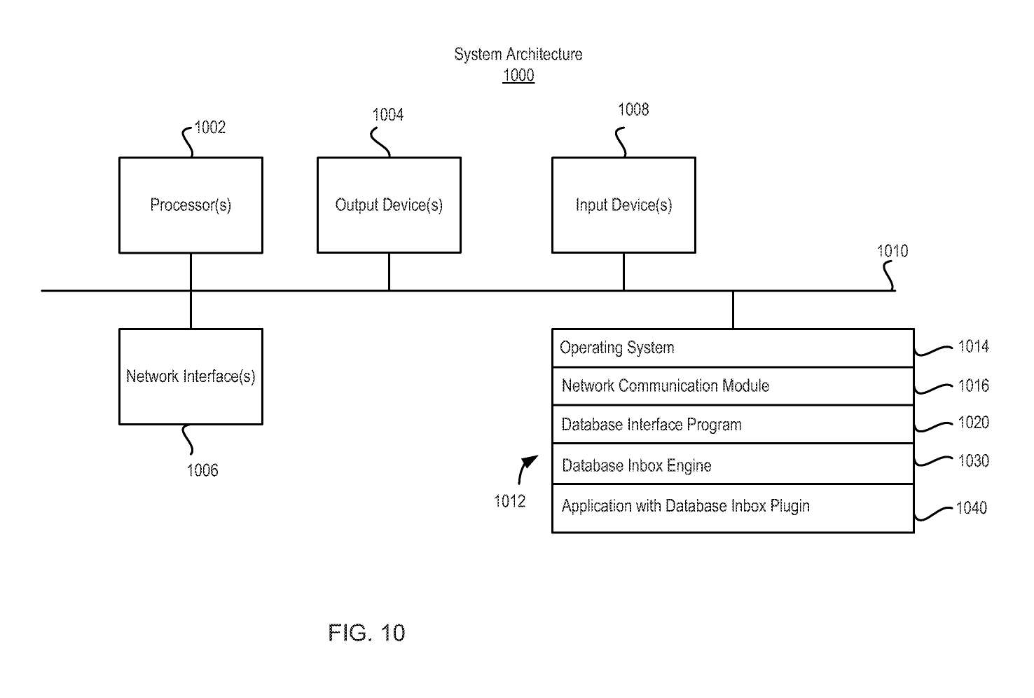

FIG. 10 is a block diagram of an exemplary system architecture 1000 for implementing the features and operations of FIGS. 1-8 and 9A-9C.

Other architectures are possible, including architectures with more or fewer components. In some implementations, architecture 1000 includes one or more processors 1002 (e.g., dual-core Intel® Xeon® Processors), one or more output devices 1004 (e.g., LCD), one or more network interfaces 1006, one or more input devices 1008 (e.g., mouse, keyboard, touch-sensitive display) and one or more computer-readable mediums 1012 (e.g., RAM, ROM, SDRAM, hard disk, optical disk, flash memory, etc.). These components can exchange communications and data over one or more communication channels 1010 (e.g., buses), which can utilize various hardware and software for facilitating the transfer of data and control signals between components.

The term “computer-readable medium” refers to a medium that participates in providing instructions to processor 1002 for execution, including without limitation, non-volatile media (e.g., optical or magnetic disks), volatile media (e.g., memory) and transmission media. Transmission media includes, without limitation, coaxial cables, copper wire and fiber optics.

Computer-readable medium 1012 can further include operating system 1014 (e.g., a Linux® operating system), network communication module 1016, database interface program 1020, database inbox engine 1030, and application program 1040. Operating system 1014 can be multi-user, multiprocessing, multitasking, multithreading, real time, etc. Operating system 1014 performs basic tasks, including but not limited to: recognizing input from and providing output to devices 1006, 1008; keeping track and managing files and directories on computer-readable mediums 1012 (e.g., memory or a storage device); controlling peripheral devices; and managing traffic on the one or more communication channels 1010. Network communications module 1016 includes various components for establishing and maintaining network connections (e.g., software for implementing communication protocols, such as TCP/IP, HTTP, etc.).

Database interface program 1020 can include computer instructions that, when executed, cause processor 1002 to perform operations of inserting data into or retrieving data from a database. Database interface program 1020 can include interfaces to one or more databases on a file system. Database interface program 1020 can include dynamic database interface 616 as described in reference to FIG. 7. The databases can be organized under a hierarchical folder structure, the folders mapping to directories in the file system. Database inbox engine 1030 can include database backend and include computer instructions that, when executed, cause processor 1002 to perform operations as described above in reference to FIGS. 8 and 9A-9C. Application program 1040 can be an application program that includes a database inbox plugin. Application program 1040 can include computer instructions that, when executed, cause processor 1002 to perform operations as described above in reference to FIG. 4.

Architecture 1000 can be implemented in a parallel processing or peer-to-peer infrastructure or on a single device with one or more processors. Software can include multiple software components or can be a single body of code.

The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language (e.g., Objective-C, Java), including compiled or interpreted languages, and it can be deployed in any form, including as a stand-alone program or as a module, component, subroutine, a browser-based web application, or other unit suitable for use in a computing environment.

Suitable processors for the execution of a program of instructions include, by way of example, both general and special purpose microprocessors, and the sole processor or one of multiple processors or cores, of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor or a retina display device for displaying information to the user, and a touch screen input device or a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

A number of implementations of the invention have been described. Nevertheless, it will be understood that various modifications can be made without departing from the spirit and scope of the invention.

What is claimed is:

1. A method comprising:
receiving, by a database inbox, a data object, the database inbox having an inbox display area and being configured to receive and store data objects each having a distinct data type;
receiving a request to insert the data object into a data record having one more data fields, each data field having a data field type, the data record being displayed in a form display area, the request including an input moving the data object from the inbox display area to the form display area;
determining whether the data object is being moved to an existing data field; and
based on a result from the determining, modifying at least one of the data object or a schema of the data record wherein a representation of the data object is inserted into the data record and provided for display in the form display area, wherein the method is performed by one or more computers.

2. The method of claim 1, wherein the database inbox includes a backend table having one or more data records organized in one data column, each of the one or more data records corresponding to a respective data object.

3. The method of claim 1, wherein receiving the data object comprises:
receiving the data object as pushed into the database inbox by an application program.

4. The method of claim 3, wherein receiving the data object as pushed into the database inbox comprises:
receiving, in the application program, an input selecting a content item;
creating, by a plugin of the application program configured to communicate with the database inbox, the data object based on the selected content item;
pushing, by the plugin, the data object to the database inbox; and
receiving, by the database inbox, the pushed data object.

5. The method of claim 1, wherein receiving the data object comprises:
receiving the data object through a pull by the database inbox from an application program.

6. The method of claim 5, wherein receiving the data object through the pull comprises:
receiving an input in the display area of the database inbox;
providing for display a user interface for selecting a content item displayed by an application program;
generating the data object based on the content item selected through the user interface; and
pulling the data object into the database inbox.

7. The method of claim 1, wherein modifying at least one of the data object or the schema of the data record comprises:
determining an object conversion rule using a type mapping table based on the data type of the data object and data field type of the existing data field;
converting the data object into a target object according to the object conversion rule; and
designating the target object as the representation of the data object.

8. The method of claim 7, wherein converting the data object comprises extracting metadata from the data object, the metadata indicating one or more characteristics of a content item in the data object.

9. The method of claim 7, wherein modifying at least one of the data object or the schema of the data record comprises:
creating a new data field in the schema, the new data field having a data field type that corresponds to the data type of the data object; and
propagating the new data field to other data records according to the schema.

10. The method of claim 1, comprising:
upon receiving the data object, determining that a number of data objects in the database inbox exceeds a threshold; and then
creating a plurality of levels in the database inbox, including creating at least one folder at a first level, the folder containing at least two data objects moved from the first level to a second level, such that a total number of data objects and folders at the first level does not exceed the threshold.

11. A non-transitory storage device storing computer instructions operable to cause one or more processors to perform operations comprising:
receiving, by a database inbox, a data object, the database inbox having an inbox display area and being configured to receive and store data objects each having a distinct data type;
receiving a request to insert the data object into a data record having one more data fields, each data field having a data field type, the data record being displayed in a form display area, the request including an input moving the data object from the inbox display area to the form display area;
determining whether the data object is being moved to an existing data field; and
based on a result from the determining, modifying at least one of the data object or a schema of the data record wherein a representation of the data object is inserted into the data record and provided for display in the form display area.

12. The storage device of claim 11, wherein the database inbox includes a backend table having one or more data records organized in one data column, each of the one or more data records corresponding to a respective data object.

13. The storage device of claim 11, wherein receiving the data object comprises:
receiving the data object as pushed into the database inbox by an application program.

14. The storage device of claim 13, wherein receiving the data object as pushed into the database inbox comprises:
receiving, in the application program, an input selecting a content item;
creating, by a plugin of the application program configured to communicate with the database inbox, the data object based on the selected content item;
pushing, by the plugin, the data object to the database inbox; and
receiving, by the database inbox, the pushed data object.

15. The storage device of claim 11, wherein receiving the data object comprises:
receiving the data object through a pull by the database inbox from an application program.

16. The storage device of claim 15, wherein receiving the data object through the pull comprises:
receiving an input in the display area of the database inbox;
providing for display a user interface for selecting a content item displayed by an application program;
generating the data object based on the content item selected through the user interface; and
pulling the data object into the database inbox.

17. The storage device of claim 11, wherein modifying at least one of the data object or the schema of the data record comprises:
determining an object conversion rule using a type mapping table based on the data type of the data object and data field type of the existing data field;
converting the data object into a target object according to the object conversion rule; and
designating the target object as the representation of the data object.

18. The storage device of claim 17, wherein converting the data object comprises extracting metadata from the data object, the metadata indicating one or more characteristics of a content item in the data object.

19. The storage device of claim 17, wherein modifying at least one of the data object or the schema of the data record comprises:
creating a new data field in the schema, the new data field having a data field type that corresponds to the data type of the data object; and
propagating the new data field to other data records according to the schema.

20. The storage device of claim 11, comprising:
upon receiving the data object, determining that a number of data objects in the database inbox exceeds a threshold; and then
creating a plurality of levels in the database inbox, including creating at least one folder at a first level, the folder containing at least two data objects moved from the first level to a second level, such that a total number of data objects and folders at the first level does not exceed the threshold.

21. A system comprising:
one or more processors configured to perform operations comprising:
receiving, by a database inbox, a data object, the database inbox having an inbox display area and being configured to receive and store data objects each having a distinct data type;
receiving a request to insert the data object into a data record having one more data fields, each data field having a data field type, the data record being displayed in a form display area, the request including an input moving the data object from the inbox display area to the form display area;
determining whether the data object is being moved to an existing data field; and
based on a result from the determining, modifying at least one of the data object or a schema of the data record wherein a representation of the data object is inserted into the data record and provided for display in the form display area.

22. The system of claim 21, wherein the database inbox includes a backend table having one or more data records organized in one data column, each of the one or more data records corresponding to a respective data object.

23. The system of claim 21, wherein receiving the data object comprises:
receiving the data object as pushed into the database inbox by an application program.

24. The system of claim 23, wherein receiving the data object as pushed into the database inbox comprises:
receiving, in the application program, an input selecting a content item;
creating, by a plugin of the application program configured to communicate with the database inbox, the data object based on the selected content item;
pushing, by the plugin, the data object to the database inbox; and
receiving, by the database inbox, the pushed data object.

25. The system of claim 21, wherein receiving the data object comprises:
receiving the data object through a pull by the database inbox from an application program.

26. The system of claim 25, wherein receiving the data object through the pull comprises:
receiving an input in the display area of the database inbox;
providing for display a user interface for selecting a content item displayed by an application program;
generating the data object based on the content item selected through the user interface; and
pulling the data object into the database inbox.

27. The system of claim 21, wherein modifying at least one of the data object or the schema of the data record comprises:
determining an object conversion rule using a type mapping table based on the data type of the data object and data field type of the existing data field;
converting the data object into a target object according to the object conversion rule; and
designating the target object as the representation of the data object.

28. The system of claim 27, wherein converting the data object comprises extracting metadata from the data object, the metadata indicating one or more characteristics of a content item in the data object.

29. The system of claim 27, wherein modifying at least one of the data object or the schema of the data record comprises:
creating a new data field in the schema, the new data field having a data field type that corresponds to the data type of the data object; and
propagating the new data field to other data records according to the schema.

30. The system of claim 21, comprising:
upon receiving the data object, determining that a number of data objects in the database inbox exceeds a threshold; and then
creating a plurality of levels in the database inbox, including creating at least one folder at a first level, the folder containing at least two data objects moved from the first level to a second level, such that a total number of data objects and folders at the first level does not exceed the threshold.
